(19) United States
(12) Patent Application Publication
(10) Pub. No.: US 2023/0340965 A1
(43) Pub. Date: Oct. 26, 2023

(54) BLOWER

(71) Applicant: Makita Corporation, Anjo-shi (JP)

(72) Inventors: Shinsuke NAKA, Anjo-shi (JP); Ryoji ZAMA, Anjo-shi (JP)

(73) Assignee: Makita Corporation, Anjo-shi (JP)

(21) Appl. No.: 18/300,063

(22) Filed: Apr. 13, 2023

(30) Foreign Application Priority Data
Apr. 20, 2022 (JP) 2022-069628

(51) Int. Cl. F04D 29/58; F04D 25/06; F04D 19/00; F04D 29/54

(52) U.S. Cl. CPC F04D 29/584; F04D 25/06; F04D 19/002; F04D 29/541

(57) ABSTRACT

A blower may include an airflow pipe disposed between an inlet and an outlet, an axial flow fan including a hub and a plurality of blades, a drive shaft, an electric motor, a motor housing, a diffuser cone, a first vent defined on the diffuser cone, and a second vent defined between the hub and the motor housing. An airflow path in which air flows from the inlet to the outlet is defined in the airflow pipe. A circulation path in which the air flows from the first vent to the second vent is defined in the airflow pipe. When a circumferential end of the second vent on the inlet side is a first end and a circumferential end of the second vent on the outlet side is a second end, an outer diameter of the first end is larger than an outer diameter of the second end.

### REFERENCE TO RELATED APPLICATIONS

This application claims priority from Japanese Patent Application No. 2022-69628 filed on Apr. 20, 2022. The entire content of the priority application is incorporated herein by reference.

### TECHNICAL FIELD

The technique disclosed herein relates to a blower.

### BACKGROUND ART

US Patent Application Publication No. 2008/0219844 describes a blower including: an inlet; an outlet; an airflow pipe disposed between the inlet and the outlet; an axial flow fan disposed in the airflow pipe and including a hub configured to rotate about a predetermined rotation axis which is along a direction in which the airflow pipe extends and a plurality of blades disposed on an outer surface of the hub; a drive shaft disposed in the airflow pipe and connected to the axial flow fan; an electric motor which is offset from the axial flow fan toward the outlet in the airflow pipe and configured to rotate the drive shaft; a motor housing that is disposed in the airflow pipe and houses the electric motor; a diffuser cone disposed in the airflow pipe and connected to an end of the motor housing on an outlet side; a first vent defined at an end of the diffuser cone on the outlet side; and a second vent defined between the hub and the motor housing along a circumferential direction of the rotation axis and having a width in an axial direction of the rotation axis. An airflow path in which air from the inlet flows to the outlet by flowing outside of the hub, outside of the motor housing, and outside of the diffuser cone is defined in the airflow pipe, and a circulation path in which the air flowing in the airflow path flows into inside of the diffuser cone through the first vent, flows inside of the motor housing, and flows toward the airflow path through the second vent is defined in the airflow pipe, and when a circumferential end of the second vent on the inlet side is a first end and a circumferential end of the second vent on the outlet side is a second end, an outer diameter of the first end is smaller than an outer diameter of the second end (or these outer diameters are equal).

### DESCRIPTION

In the blower described in US Patent Application Publication No. 2008/0219844, air flowing along the outer surface of the hub is separated from the outer surface of the hub, by which negative pressure which directs the air into the airflow path through the second vent (i.e., negative pressure which generates airflow in the circulation path) is generated. Consequently, the blower described in US Patent Application Publication No. 2008/0219844 uses the air flowing along the circulation path as cooling air for the electric motor. In the blower described in US Patent Application Publication No. 2008/0219844, however, the outer diameter of the first end is smaller than the outer diameter of the second end (or these outer diameters are equal). In this case, the air separated from the outer surface of the hub immediately comes into contact again with the outer surface of the motor housing, thus sufficient negative pressure is not generated. Thus, it may not be possible to achieve a sufficient flow rate of the cooling air for the electric motor. Thus, it may not be possible for the blower described in US Patent Application Publication No. 2008/0219844 to suitably cool the electric motor housed in the motor housing. The present disclosure provides the technique capable of suitably cooling an electric motor housed in a motor housing in a blower.

A blower disclosed herein may comprise an inlet, an outlet, an airflow pipe disposed between the inlet and the outlet, an axial flow fan disposed in the airflow pipe and including a hub configured to rotate about a predetermined rotation axis which is along a direction in which the airflow pipe extends and a plurality of blades disposed on an outer surface of the hub, a drive shaft disposed in the airflow pipe and connected to the axial flow fan, an electric motor which is offset from the axial flow fan toward the outlet in the airflow pipe and configured to rotate the drive shaft, a motor housing that is disposed in the airflow pipe and houses the electric motor, a diffuser cone disposed in the airflow pipe and connected to an end of the motor housing on an outlet side, a first vent defined at an end of the diffuser cone on the outlet side, and a second vent defined between the hub and the motor housing along a circumferential direction of the rotation axis and having a width in an axial direction of the rotation axis. An airflow path in which air from the inlet flows to the outlet by flowing outside of the hub, outside of the motor housing, and outside of the diffuser cone may be defined in the airflow pipe. A circulation path in which the air flowing in the airflow path flows into inside of the diffuser cone through the first vent, flows inside of the motor housing, and flows toward the airflow path through the second vent may be defined in the airflow pipe. When a circumferential end of the second vent on the inlet side is a first end and a circumferential end of the second vent on the outlet side is a second end, an outer diameter of the first end may be larger than an outer diameter of the second end.

In the above configuration, the air flowing along the outer surface of the hub among the air flowing in the airflow path separates from the outer surface of the hub at the first end and comes into contact again with, for example, an outer surface of the motor housing at a position offset from the second end toward the outlet. According to the above configuration, by virtue of the outer diameter of the first end being larger than the outer diameter of the second end, a distance between a point at which the air separates (i.e., a separation point) and a point at which the separated air comes into contact again (i.e., a recontact point) increases. Thus, negative pressure which generates airflow in the circulation path increases, by which a flow rate of the cooling air for the electric motor can be increased. According to the above configuration, in the blower, the electric motor housed in the motor housing can suitably be cooled.

### BRIEF DESCRIPTION OF DRAWINGS

FIG. 1 is a perspective view of an entirety of a blower 10 of an embodiment, viewed from the rear right upper side.

FIG. 2 is a disassembled view of a structure inside a blower body 13 of the blower 10 of the embodiment, viewed from the rear right upper side.

FIG. 3 is a disassembled view of an airflow unit 50 and a control unit 80 disposed on a first airflow pipe 210 and components of the airflow unit 50 of the blower 10 of the embodiment.

FIG. 4 is a cross-sectional view illustrating internal structures of the first airflow pipe 210, the airflow unit 50 and the control unit 80 of the blower 10 of the embodiment.

FIG. 5 is a cross-sectional view of components of the control unit 80 included in the blower 10 of the embodiment.

FIG. 6 is a view illustrating positional relationships of an electric motor 54, a plurality of switching elements 84, heat dissipation members 86, a mounting part 212 and an exposure hole 216 when the first airflow pipe 210 of the blower 10 of the embodiment is viewed in an up-down direction from outside in a radial direction.

FIG. 7 is a cross-sectional view illustrating positional relationships between a virtual surface V extending along an inner surface of the first airflow pipe 210 and a lower surface of a controller casing 88 in the blower 10 of the embodiment.

FIG. 8 is a view illustrating an airflow path R1 defined in the first airflow pipe 210 and a circulation path R2 defined in the airflow unit 50 in the blower 10 of the embodiment.

FIG. 9 is a view schematically illustrating how negative pressure which takes air out of the circulation path R2 toward the airflow path R1 when the air flows along the airflow path R1 in the blower 10 of the embodiment.

FIG. 10 is a cross-sectional view illustrating a first outer diameter φ1 of an outlet-side end 620 of a hub 62, a second outer diameter φ2 of an inlet-side end 560 of a motor housing 56 and a first inner diameter φ3 of the first airflow pipe 210 in the blower 10 of the embodiment.

FIG. 11 is a graph indicating a relationship between a ratio φ1/φ2 of the first outer diameter φ1 to the second outer diameter φ2 and a rate of change of each of a flow rate of cooling air and a flow rate of blowing air when the fan 52 is rotated at a constant rotation speed in the blower 10 of the embodiment.

FIG. 12 is a cross-sectional view illustrating a second inner diameter φ4 of a first vent 58b in the blower 10 of the embodiment.

FIG. 13 is a cross-sectional view illustrating internal structures of a first airflow pipe 210, an airflow unit 50 and a control unit 80 of a blower 10 of a variant.

FIG. 14 is a view schematically illustrates how negative pressure which takes air out of a circulation path R2 toward an airflow path R1 is generated when the air flows along the airflow path R1 in the blower 10 of the variant.

Representative, non-limiting examples of the present disclosure will now be described in further detail with reference to the attached drawings. This detailed description is merely intended to teach a person of skill in the art further details for practicing aspects of the present teachings and is not intended to limit the scope of the present disclosure. Furthermore, each of the additional features and teachings disclosed below may be utilized separately or in conjunction with other features and teachings to provide improved blowers as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

In one or more embodiments, the first end may be an end of the outer surface of the hub on the outlet side. The second end may be an end of an outer surface of the motor housing on the inlet side.

As a means to increase a flow rate of the cooling air for the electric motor, another member may be provided between, for example, the hub and the motor housing. On the other hand, according to the above configuration, the flow rate of the cooling air for the electric motor can be increased without providing another member between the hub and the motor housing. Consequently, the number of parts of the blower can be reduced.

In one or more embodiments, the blower may comprise a negative pressure increasing member disposed between the hub and the motor housing and including an outer surface having an axisymmetric shape about the rotation axis. The first end may be an end of the outer surface of the negative pressure increasing member on the outlet side. The second end may be an end of an outer surface of the motor housing on the inlet side.

According to the above configuration, by retrofitting the negative pressure increasing member between the hub and the motor housing of the general blower, the flow rate of the cooling air for the electric motor can be increased. Consequently, with a simple and inexpensive configuration, the flow rate of the cooling air for the electric motor can be increased. The “general blower” herein refers to a blower whose hub and motor housing are flush with each other.

In one or more embodiments, the hub may be fixed to the drive shaft. The rotation axis may be coincident with a rotation axis of the drive shaft.

According to the above configuration, the blower can be downsized as compared to the case in which a speed reducer and/or the like is provided between the hub and the drive shaft.

In one or more embodiments, a ratio of the outer diameter of the first end to the outer diameter of the second end may be within a range from 101% to 116%.

When the ratio of the outer diameter of the first end to the outer diameter of the second end is too small, negative pressure which generates airflow in the circulation path may not sufficiently be increased. In other words, the flow rate of the cooling air for the electric motor may not sufficiently be increased. On the other hand, when the ratio of the outer diameter of the first end to the outer diameter of the second end is too large, separation of the air flowing along the outer surface of the hub may disturb the airflow generated in the airflow path by driving the fan. In other words, due to disturbance of the airflow, the flow rate of the blowing air may greatly be reduced. According to the above configuration, the flow rate of the cooling air for the electric motor can sufficiently be increased and reduction of the flow rate of the blowing air can be suppressed. The “blowing air” herein refers to air exhausted from the outlet along the airflow path.

In one or more embodiments, a ratio of an inner diameter of the airflow pipe radially outside the first end to the outer diameter of the second end may be within a range from 175% to 195%.

When the ratio of the inner diameter of the airflow pipe radially outside the first end to the outer diameter of the second end is too small, increasing the outer diameter of the first end narrows the airflow path, by which pressure loss may be increased to a great extent in the airflow path. On the other hand, when the ratio of the inner diameter of the airflow pipe radially outside the first end to the outer diameter of the second end is too large, the airflow generated in the airflow path by driving the fan may be disturbed. According to the above configuration, increase in pressure loss in the airflow path can be suppressed and also disturbance of the airflow in the airflow path can be suppressed.

In one or more embodiments, the first vent may have a circumferential end having a substantially circular shape and opening along the direction in which the airflow pipe extends. A ratio of an inner diameter of the first vent to the outer diameter of the second end may be within the range from 15% to 50%.

When the ratio of the inner diameter of the first vent to the outer diameter of the second end is too small, an amount of air taken into the circulation path at the first vent may be excessively small. On the other hand, when the ratio of the inner diameter of the first vent to the outer diameter of the second end is too large, the amount of air taken into the circulation path at the first vent may be excessively large. According to the above configuration, when the first vent opens along the direction in which the airflow pipe extends, the amount of air taken into the circulation path at the first vent can be set to a suitable amount.

In one or more embodiments, the blower may comprise a battery device. The electric motor may be configured to be driven by electric power supplied from the battery device.

When the electric motor is driven by electric power supplied from an external power source, it is necessary to attach a power supply cord to the blower, which may degrade maneuverability. According to the above configuration, it is not necessary to attach the power supply cord to the blower, by which user maneuverability can further be improved. Further, since the blower can be used even at a place where an external power source cannot be provided, user convenience can also be enhanced.

In one or more embodiments, the blower may comprise a battery attachment portion including a connection terminal. The battery device may be at least one battery pack configured to be attached to and detached from the battery attachment portion.

For example, when the battery device is attached to the blower such that it cannot be attached to or detached from the blower, work using the blower cannot immediately be resumed until the battery device is charged again after the work is stopped due to the battery device being out of power. According to the above configuration, even when the work is stopped due to the battery pack being out of power, the work using the blower can immediately be resumed by replacing the battery pack with a battery pack charged in advance.

In one or more embodiments, the blower may comprise a power supply cord configured to be connected to an external power source. The electric motor may be configured to be driven by electric power supplied from the external power source.

When the electric motor is driven using the electric power supplied from the battery source included in the blower, it is necessary to charge the battery device in advance, which may be an inconvenience for a user. According to the above configuration, the blower can immediately be used by connecting the power supply cord to the external power source, thus preparation such as charging of the battery device in advance is not necessary. Consequently, the inconvenience which the user may feel can be reduced.

### Embodiment

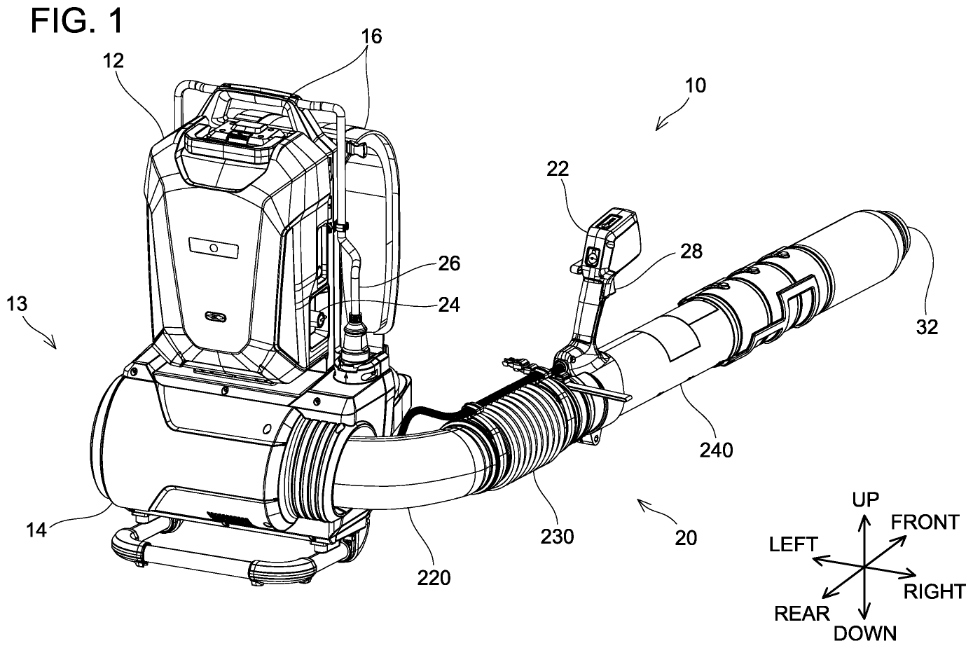

As illustrated in FIG. 1, a blower 10 includes a battery device 12, a blower body 13, and a pair of shoulder belts 16. A user wears the pair of shoulder belts 16 on his/her shoulder, by which the user can hold the blower 10 on his/her back. In other words, the blower 10 of the present embodiment is a backpack blower. In the explanation below, when the user wears the blower 10 on his/her back, an up-down direction, a left-right direction and a front-rear direction viewed from the user will be referred to as an up-down direction, a left-right direction and a front-rear direction of the blower 10.

### Configuration of Battery Device 12

The battery device 12 houses a plurality of battery cells (not illustrated). The battery device 12 includes a charging connector 24 and a discharging cable 26. The discharging cable 26 is connected to the blower body 13. The plurality of battery cells can be charged from an external power source (not illustrated) by connecting a charging cable (not illustrated) extending from the external power source to the charging connector 24. The plurality of battery cells can discharge to the blower body 13 via the discharging cable 26.

### Configuration of Blower Body 13

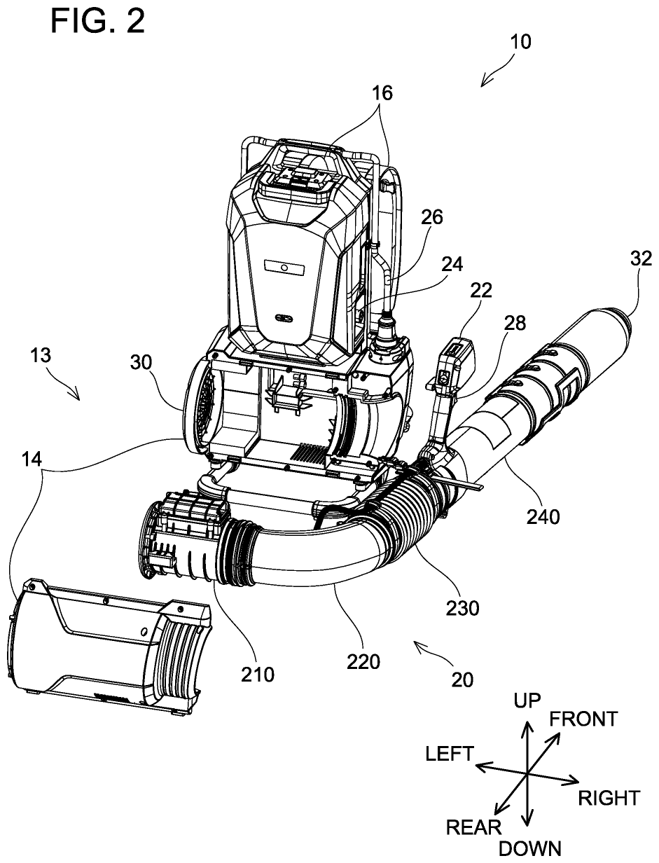

The blower body 13 includes an outer housing 14, an airflow pipe 20 and an operation grip 22. As illustrated in FIG. 2, the outer housing 14 includes an inlet 30 on its left side. The inlet 30 connects between the inside and outside of the outer housing 14 such that the inside and the outside are in communication. The outer housing 14 houses a part of the airflow pipe 20. The outer housing 14 holds the airflow pipe 20 such that a direction along which a first airflow pipe 210 to be described later extends is defined along the left-right direction.

### Configuration of Airflow Pipe 20

The airflow pipe 20 includes a first airflow pipe 210 which is substantially cylindrical and extends in the left-right direction, a second airflow pipe 220 which is substantially cylindrical and bent toward the front as it extends rightward, a third airflow pipe 230 which has an accordion structure and extends in the front-rear direction, and a fourth airflow pipe 240 which is substantially cylindrical and extends in the front-rear direction. The third airflow pipe 230 is configured to extend and contract. The first airflow pipe 210, the second airflow pipe 220, the third airflow pipe 230 and the fourth airflow pipe 240 are connected in series. The left end of the first airflow pipe 210 is directed to the inlet 30 and communicates with the inlet 30. The front end of the fourth airflow pipe 240 includes an outlet 32. As described above, the airflow pipe 20 is configured such that its one end communicates with the inlet 30 and the other end functions as the outlet 32. In the present disclosure, with respect to the direction in which the airflow pipe 20 extends, a side toward the inlet 30 may be referred to an inlet side and a side toward the outlet 32 may be referred to as an outlet side. For example, the left side of the first airflow pipe 210 may be referred to as the inlet side and the right side of the first airflow pipe 210 may be referred to as the outlet side.

### Configuration of Operation Grip 22

As illustrated in FIG. 1, an operation grip 22 is disposed on the fourth airflow pipe 240 at a position which allows the user to operate the operation grip 22 by gripping it. The user adjusts a posture of the fourth airflow pipe 240 while gripping the operation grip 22, by which the user can adjust a direction in which the outlet 32 is oriented. A plurality of switches, such as a trigger 28, to be operated by the user is disposed on the operation grip 22.

### Configuration of Airflow Unit 50

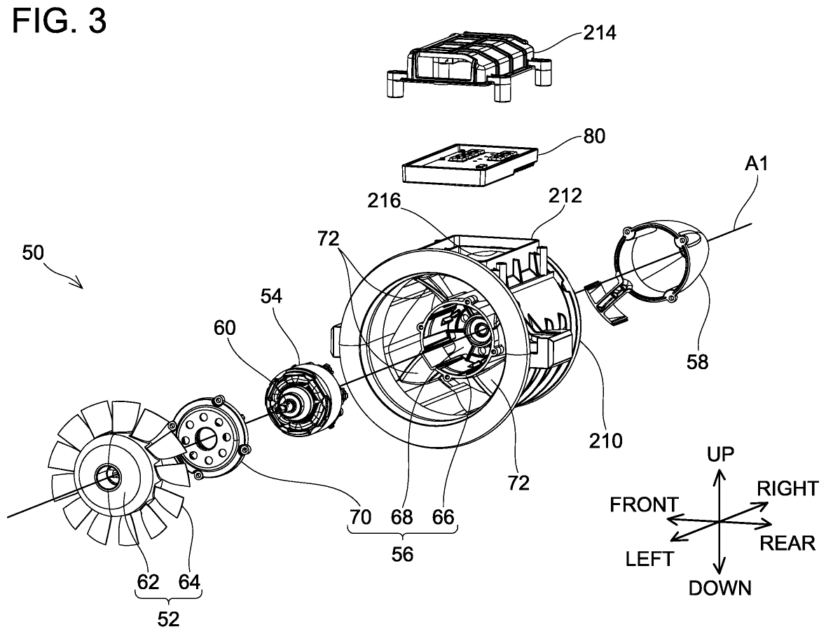

As illustrated in FIG. 3, the blower body 13 further includes an airflow unit 50 disposed in the airflow pipe 20 and configured to supply air from the inlet 30 toward the outlet 32 through the airflow pipe 20. The airflow unit 50 includes a fan 52, an electric motor 54 configured to drive the fan 52, a motor housing 56 that houses the electric motor 54, and a diffuser cone 58 connected to the right end of the motor housing 56.

### Configuration of Electric Motor 54

The electric motor 54 includes a drive shaft 60 configured to rotate about a rotation axis A1 which is along the left-right direction. The electric motor 54 of the present embodiment is a brushless motor and includes a stator and a rotor (not illustrated). The drive shaft 60 is fixed to the rotor, and the drive shaft 60 rotates about the rotation axis A1 when electric power is supplied to the electric motor 54.

### Configuration of Fan 52

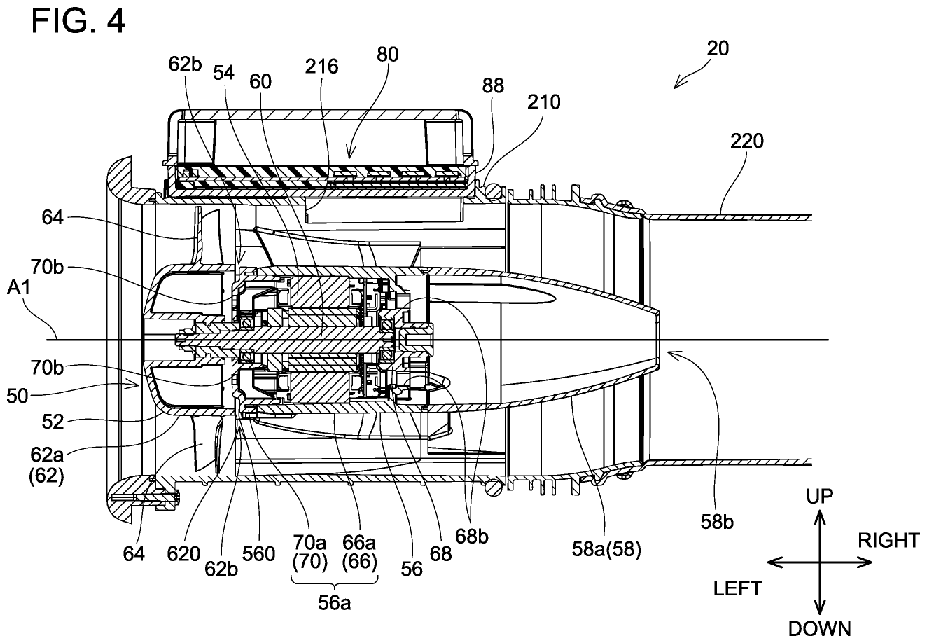

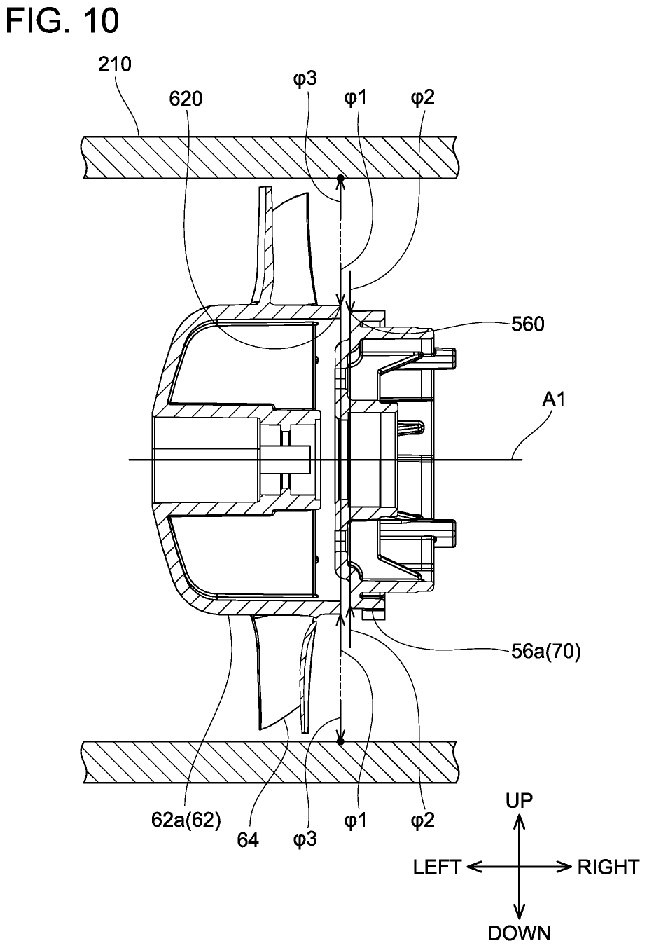

As illustrated in FIG. 4, the fan 52 includes a hub 62 fixed to the drive shaft 60 from the inlet side and a plurality of blades 64 disposed at a first outer surface 62a of the hub 62. The hub 62 is configured to rotate about the rotation axis A1. The first outer surface 62a has an axisymmetric shape about the rotation axis A1 of the drive shaft 60. An outlet-side end 620, which is the end of the first outer surface 62a on the outlet side, has a first outer diameter φ1 (see FIG. 10). In the present embodiment, the fan 52 is an axial flow fan. For example, when the fan 52 rotates counterclockwise as the airflow unit 50 is viewed from the inlet side, the fan 52 generates airflow from the inlet side toward the outlet side along the rotation axis A1 (e.g., rightward in FIG. 4).

### Configuration of Motor Housing 56

As illustrated in FIG. 3, the motor housing 56 includes a cylindrical portion 66 extending along the rotation axis A1, a bottom portion 68 disposed on the outlet side of the electric motor 54, and a lid portion 70 disposed on the inlet side of the electric motor 54. The motor housing 56 is supported within the first airflow pipe 210 by a plurality of support members 72 formed at the cylindrical portion 66. The cylindrical portion 66, the bottom portion 68, the plurality of support members 72 and the first airflow pipe 210 are seamlessly and integrally formed. The lid portion 70 is fixed to the cylindrical portion 66 by screws (not illustrated). Thus, the electric motor 54 is housed in the motor housing 56 by inserting the electric motor 54 into the cylindrical portion 66 and then fixing the lid portion 70 to the cylindrical portion 66. In the present embodiment, resin such as nylon is used for the cylindrical portion 66, the bottom portion 68, the lid portion 70, the plurality of support members 72, and the first airflow pipe 210.

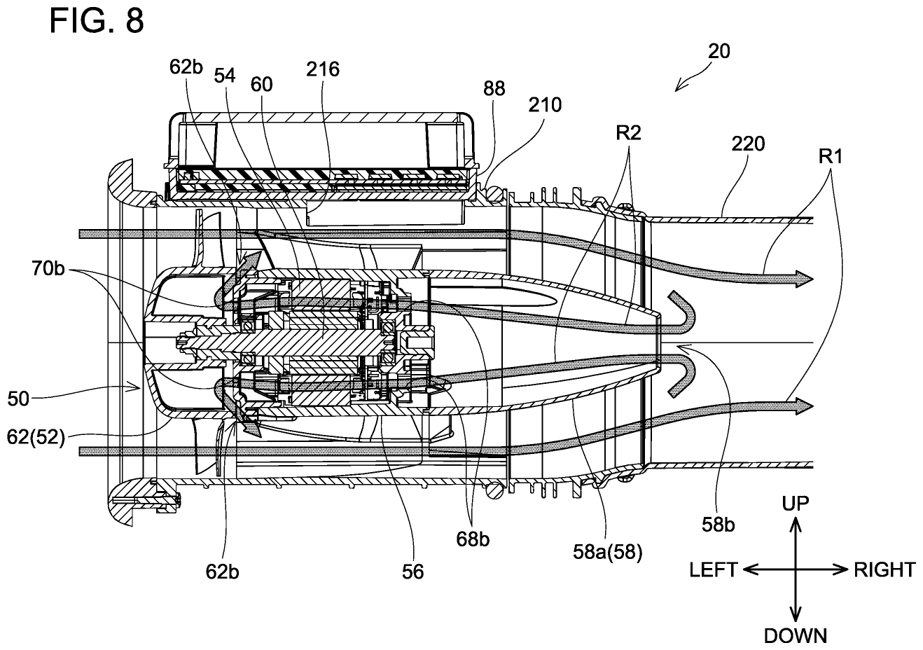

As illustrated in FIG. 4, the cylindrical portion 66 includes an outer surface 66a having a substantially cylindrical shape about the rotation axis A1 of the drive shaft 60. The lid portion 70 includes an outer surface 70a having an axisymmetric shape about the rotation axis A1. With the lid portion 70 fixed to the cylindrical portion 66, the outer surface 66a and the outer surface 70a are substantially smoothly connected to each other along the rotation axis A1. Thus, in the present disclosure, the outer surface 66a and the outer surface 70a may collectively be referred to as “second outer surface 56a”. An inlet-side end 560, which is the end of the second outer surface 56a on the inlet side, has a second outer diameter φ2 (see FIG. 10). Here, a second vent 62b is defined between the outlet-side end 620 of the hub 62 and the inlet-side end 560 of the motor housing 56. The second vent 62b is defined along a circumferential direction of the rotation axis A1 between the outlet-side end 620 and the inlet-side end 560. The second vent 62b has a width in the axial direction of the rotation axis A1. In view of the above, the second vent 62b is defined such that its circumferential end is constituted of the outlet-side end 620 and the inlet-side end 560. The second vent 62b connects between the inside of the hub 62 and an airflow path R1 (see FIG. 8, to be described later) such that they are in communication.

The bottom portion 68 includes first communication holes 68b defined between the electric motor 54 and the diffuser cone 58 in the direction along which the rotation axis A1 extends. The first communication holes 68b connect between the inside of the motor housing 56 and the inside of the diffuser cone 58 such that they are in communication. In the present embodiment, the first communication holes 68b are defined with a predetermined angular interval (e.g., interval of 60 degrees) from one another in the circumferential direction. The lid portion 70 includes second communication holes 70b defined between the hub 62 and the electric motor 54 in the direction in which the rotation axis A1 extends. The second communication holes 70b connect between the inside of the hub 62 and the inside of the motor housing 56 such that they are in communication. In the present embodiment, the second communication holes 70b are defined with a predetermined angular interval (e.g., interval of 40 degrees) from one another in the circumferential direction.

### Configuration of Diffuser Cone 58

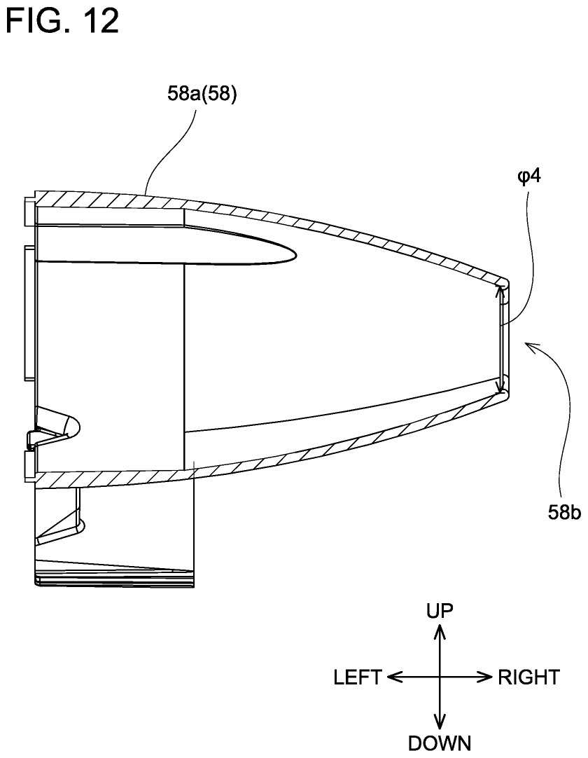

The diffuser cone 58 is connected to the outlet-side end of the cylindrical portion 66 of the motor housing 56 and extends along the rotation axis A1. A part of the diffuser cone 58 extends toward the outlet side beyond the right end of the first airflow pipe 210. In other words, the diffuser cone 58 extends in both the first airflow pipe 210 and the second airflow pipe 220. The diffuser cone 58 includes a third outer surface 58a having an axisymmetric shape about the rotation axis A1. The third outer surface 58a is smoothly connected to the second outer surface 56a along the direction in which the rotation axis A1 extends. A diameter of the third outer surface 58a is reduced from the inlet side toward the outlet side along the rotation axis A1. The diffuser cone 58 includes a first vent 58b which has a substantially circular shape and whose circumferential end is the outlet-side end of the third outer surface 58a. The first vent 58b is open along the direction in which the rotation axis A1 extends. The first vent 58b has a second inner diameter φ4 (see FIG. 12). The first vent 58b connects between the airflow path R1 (see FIG. 8) to be described and the inside of the diffuser cone 58 such that they are in communication.

### Configuration of Control Unit 80

As illustrated in FIG. 3, the blower body 13 further includes a control unit 80 configured to control the electric motor 54 of the airflow unit 50. The control unit 80 is disposed at a mounting part 212 disposed at a top portion of the first airflow pipe 210. The control unit 80 is fixed to the first airflow pipe 210 by the mounting part 212 and the cover member 214 to be screwed to the mounting part 212. The control unit 80 is electrically connected to each of the battery device 12 (see FIG. 1), the trigger 28 (see FIG. 1) and the electric motor 54. When the trigger 28 is operated by the user, the control unit 80 adjusts electric power supplied from the battery device 12 and supplies the same to the electric motor 54 to drive the electric motor 54. In the present embodiment, the control unit 80 is configured to control the electric motor 54 so that the fan 52 generates airflow from the inlet side toward the outlet side along the rotation axis A1.

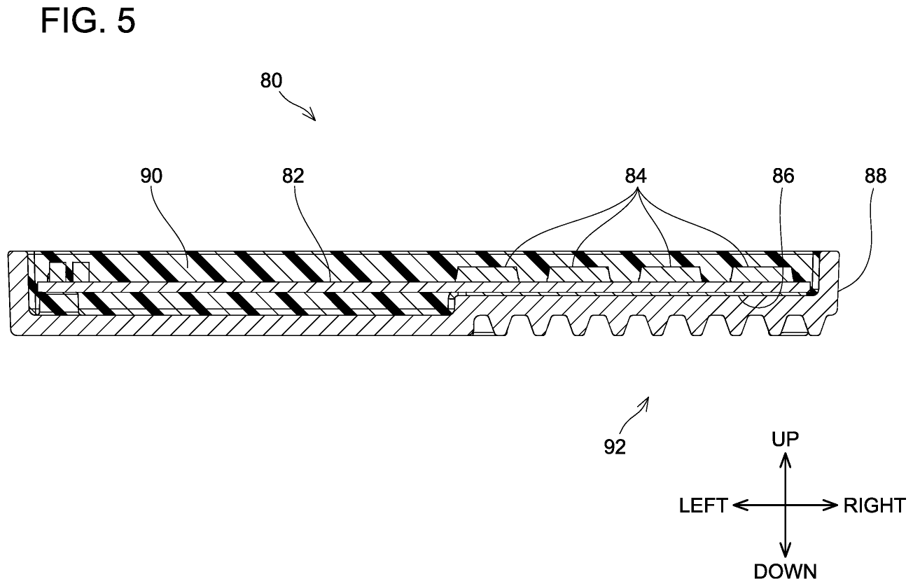

As illustrated in FIG. 5, the control unit 80 includes a control board 82, a plurality of switching elements 84 disposed on the upper surface of the control board 82, heat dissipation members 86 disposed in tight contact with the lower surface of the control board 82, a controller casing 88 that houses the control board 82, the plurality of switching elements 84 and the heat dissipation members 86, and potting resin 90 that seals the control board 82, the plurality of switching elements 84 and the heat dissipation members 86. The heat dissipation members 86 are also in tight contact with the upper surface of the controller casing 88. The controller casing 88 includes a plurality of fins 92 at a part of its lower surface. The plurality of switching elements 84 is disposed above a portion of the controller casing 88 where the plurality of fins 92 is disposed. In the present embodiment, a sheet-shaped aluminum alloy is used for the heat dissipation members 86. In the present embodiment, a metallic material such as aluminum is used for the controller casing 88. In the present embodiment, the plurality of switching elements 84 is FETs (field effect transistors) and constitutes an inverter circuit. Thus, the control unit 80 is configured to convert direct power supplied from the battery device 12 (see FIG. 1) to three-phase alternating power and supply the same to the electric motor 54.

As illustrated in FIG. 4, an upper portion of the first airflow pipe 210 comprises an exposure hole 216 connecting the inside and the outside of the first airflow pipe 210 such that they are in communication in the radial direction of the first airflow pipe 210. The exposure hole 216 is offset from the fan 52 toward the outlet side. The control unit 80 is attached to the first airflow pipe 210 such that a part of the controller casing 88 covers the entirety of the exposure hole 216 from outside in the radial direction of the first airflow pipe 210. With the control unit 80 attached to the first airflow pipe 210, a part of the lower surface of the controller casing 88 where the plurality of fins 92 is disposed (see FIG. 5) is exposed to the airflow path R1 (see FIG. 8) to be described later.

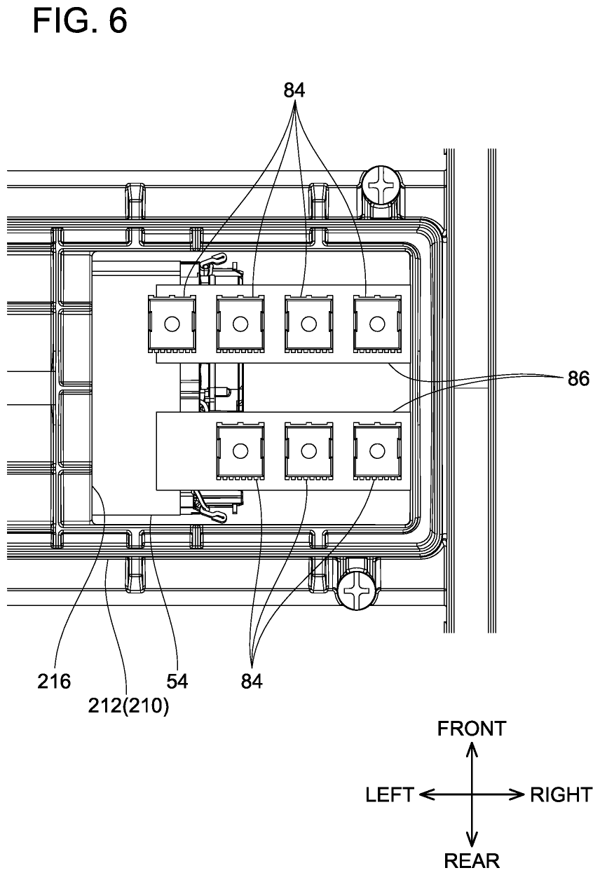

As illustrated in FIG. 6, in the present embodiment, a part of the electric motor 54, the plurality of switching elements 84 and the heat dissipation members 86 are disposed such that these members and the exposure hole 216 overlap when the exposure hole 216 is viewed along the up-down direction from the outside of the first airflow pipe 210 in the radial direction. It should be noted that, in FIG. 6, components except the electric motor 54, the plurality of switching elements 84, the heat dissipation members 86, the mounting part 212 (the first airflow pipe 210) and the exposure hole 216 are omitted for clearer explanation.

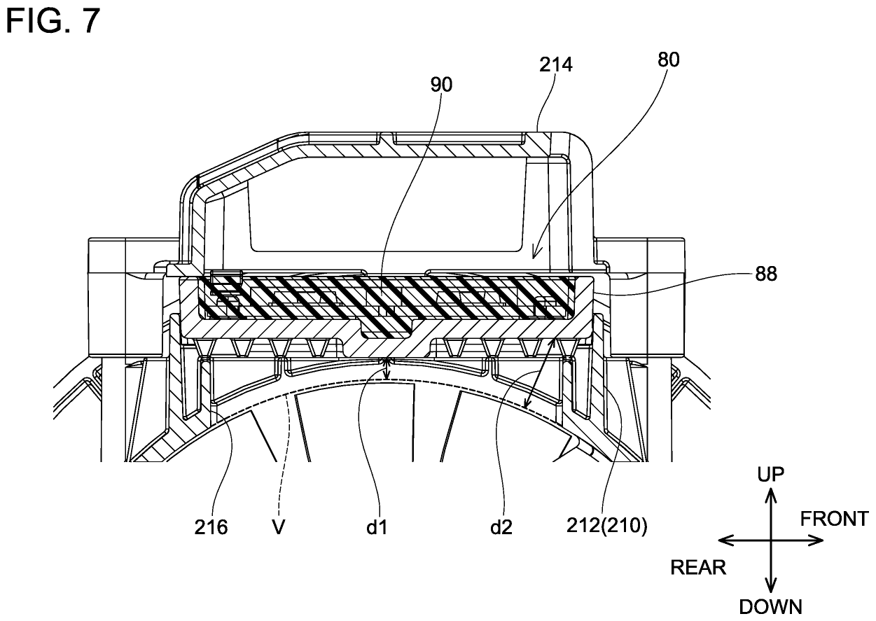

As illustrated in FIG. 7, the lower surface of the controller casing 88 has a substantially planar shape extending along the front-rear and left-right directions. The lower surface of the controller casing 88 is offset outwardly in the radial direction of the first airflow pipe 210 from a virtual surface V. The virtual surface V extends along the inner surface of the first airflow pipe 210 at a part where the exposure hole 216 is defined. In the radial direction of the first airflow pipe 210, a minimum distance d1 between the lower surface of the controller casing 88 and the virtual surface V is 2 mm. In the radial direction of the first airflow pipe 210, a maximum distance d2 between the lower surface of the controller casing 88 and the virtual surface V is 12 mm.

### Airflow Path R1

As illustrated in FIG. 8, the airflow path R1 which extends from the left end of the first airflow pipe 210 to the second airflow pipe 220 passing through the outside of the hub 62, the outside of the motor housing 56 and the outside of the diffuser cone 58 in this order is defined in the airflow pipe 20. Although not illustrated, after reaching the second airflow pipe 220, the airflow path R1 further passes through the third airflow pipe 230 (see FIG. 2) and the fourth airflow pipe 240 (see FIG. 2) and then reaches the outlet 32 (see FIG. 2). In the blower 10 of the present embodiment, when the fan 52 generates airflow from the inlet side toward the outlet side, air from the inlet 30 flows to the outlet 32 through the outside of the hub 62, the outside of the motor housing 56 and the outside of the diffuser cone 58 in the airflow path R1.

As described above, the plurality of fins 92 (see FIG. 5) of the controller casing 88 which covers the exposure hole 216 is exposed to the airflow path R1. Thus, the air flowing along the airflow path R1 guides the heat dissipated from the plurality of fins 92 exposed to the airflow path R1 to the outlet 32. In other words, the air flowing along the airflow path R1 is used as cooling air which suppresses temperature rise in the control unit 80. In the blower 10 of the present embodiment, all the air used as the cooling air is exhausted from the outlet 32. Thus, in the blower 10 of the present embodiment, the control unit 80 can be cooled without reducing the flow rate of blowing air.

### Circulation Path R2

A circulation path R2 which extends from the airflow path R1 and goes back to the airflow path R1 through the first vent 58b, the inside of the diffuser cone 58, the first communication holes 68b, the inside of the motor housing 56, the second communication holes 70b, the inside of the hub 62 and the second vent 62b in this order is defined in the airflow unit 50. In the circulation path R2, the air flowing in the airflow path R1 flows into the diffuser cone 58 through the first vent 58b, flows through the inside of the motor housing 56, and flows toward the airflow path R1 through the second vent 62b.

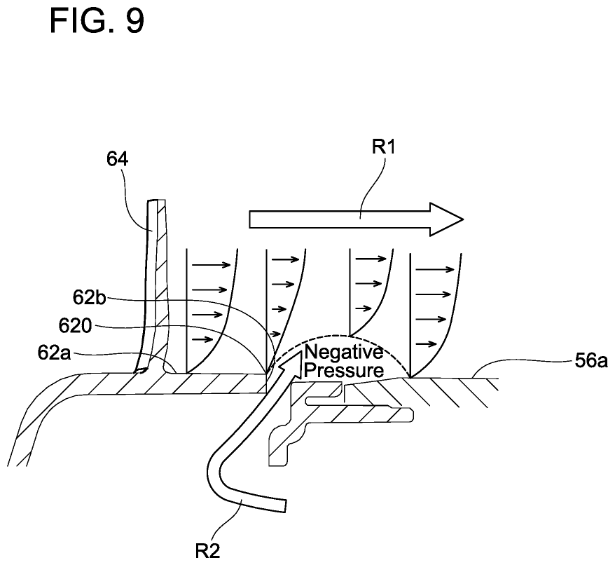

As illustrated in FIG. 9, when the air flows along the airflow path R1, the air flowing along the first outer surface 62a separates from the first outer surface 62a at the outlet-side end 620, by which negative pressure which takes the air out of the circulation path R2 toward the airflow path R1 is generated at the second vent 62b. On this occasion, as illustrated in FIG. 8, negative pressure which takes the air into the circulation path R2 from the airflow path R1 is generated at the first vent 58b. As described above, when the air flows along the airflow path R1, a part of the air flowing along the airflow path R1 flows along the circulation path R2. The air flowing along the circulation path R2 guides the heat generated in the electric motor 54 housed in the motor housing 56 toward the airflow path R1. In other words, the air flowing along the circulation path R2 is used as cooling air which suppresses temperature rise in the electric motor 54.

### Negative Pressure Increasing Mechanism in Vicinity of Second Vent 62b

As illustrated in FIG. 10, in the present embodiment, the first outer diameter φ1 of the outlet-side end 620 of the hub 62 is larger than the second outer diameter φ2 of the inlet-side end 560 of the motor housing 56. As described above, each of the hub 62 and the motor housing 56 has an axisymmetric shape about the rotation axis A1 of the drive shaft 60, thus the inlet-side end 560 is offset inward in the radial direction of the rotation axis A1 from the outlet-side end 620. Consequently, a distance from a point at which the air flowing along the first outer surface 62a separates from the first outer surface 62a (i.e., separation point) to a point at which the separated air attaches again to the second outer surface 56a (i.e., re-attachment point) increases. As a result, negative pressure which generates airflow in the circulation path R2 increases. Thus, in the blower 10 of the present embodiment, the flow rate of the cooling air for cooling the electric motor 54 can be increased.

### Ratio φ1/φ2 of First Outer Diameter φ1 to Second Outer Diameter φ2

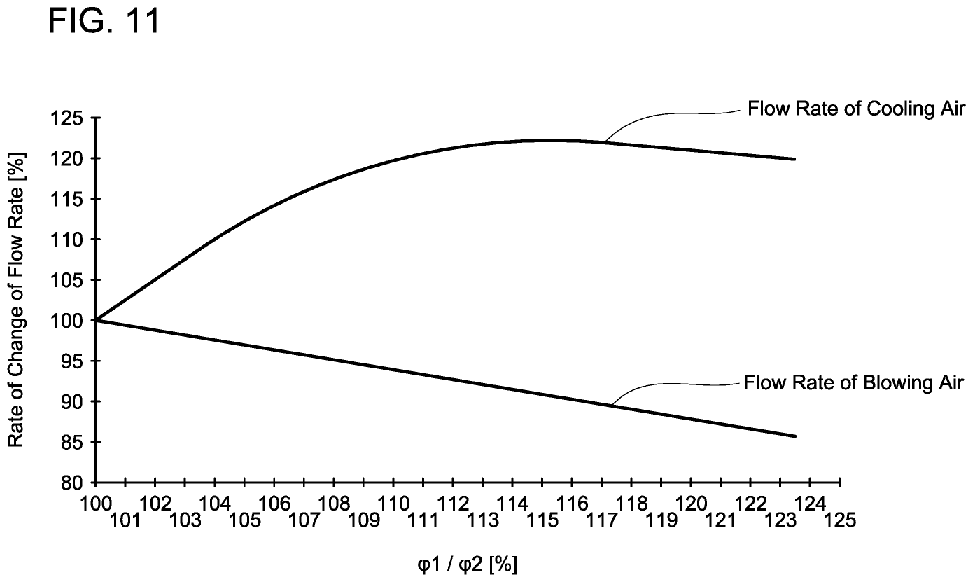

As illustrated in FIG. 11, the flow rate of the cooling air for cooling the electric motor 54 (flow rate of the cooling air) and the flow rate of the blowing air change depending on a ratio φ1/φ2 of the first outer diameter φ1 to the second outer diameter φ2. The flow rate of the cooling air monotonically increases when the ratio φ1/φ2 of the first outer diameter φ1 to the second outer diameter φ2 increases from 100% to 115%, while the flow rate of the cooling air monotonically decreases when the ratio φ1/φ2 of the first outer diameter φ1 to the second outer diameter φ2 increases beyond 116%. The flow rate of the blowing air monotonically decreases as the ratio φ1/φ2 of the first outer diameter φ1 to the second outer diameter φ2 increases. Thus, when the ratio φ1/φ2 of the first outer diameter φ1 to the second outer diameter φ2 is within a range of 101% to 116%, decrease in the flow rate of the blowing air can be suppressed while the flow rate of the cooling air is efficiently increased. In FIG. 11, with respect to the rate of change of each of the flow rate of the cooling air and the flow rate of the blowing air when the ratio φ1/φ2 is changed, the rate of change in the case of φ1/φ2 being 100% is indicated as 100%.

In particular, when the ratio φ1/φ2 of the first outer diameter φ1 to the second outer diameter φ2 increases from 100% to 103%, a gradient of the rate of change of the flow rate of cooling air (rate of increase) is relatively large. A gradient of the rate of change of the flow rate of the blowing air (rate of decrease) is substantially constant regardless of the ratio φ1/φ2 of the first outer diameter φ1 to the second outer diameter φ2. Accordingly, when the ratio φ1/φ2 of the first outer diameter φ1 to the second outer diameter φ2 is 103%, it is possible to further increase the flow rate of the cooling air efficiently while further suppressing decrease in the flow rate of the blowing air. For the above reason, in the blower 10 of the present embodiment, the ratio φ1/φ2 of the first outer diameter φ1 to the second outer diameter φ2 is 103%.

### Ratio φ3/φ2 of First Inner Diameter φ3 to Second Outer Diameter φ2

As illustrated in FIG. 10, the first airflow pipe 210 has a first inner diameter φ3 radially outside the outlet-side end 620. When the ratio φ3/φ2 of the first inner diameter φ3 to the second outer diameter φ2 is too small, increasing the first outer diameter φ1 narrows the airflow path R1, by which pressure loss may be increased to a great extent in the airflow path R1. On the other hand, when the ratio φ3/φ2 of the first inner diameter φ3 to the second outer diameter φ2 is too large, the airflow generated in the airflow path R1 by driving the fan 52 may be disturbed. In the present embodiment, the ratio φ3/φ2 of the first inner diameter φ3 to the second outer diameter φ2 is 187%. Consequently, increase in pressure loss in the airflow path R1 can be suppressed and also disturbance of the airflow in the airflow path R1 can be suppressed.

### Ratio φ4/φ2 of Second Inner Diameter φ4 to Second Outer Diameter φ2

Further, when the ratio φ4/φ2 of the second inner diameter φ4 of the first vent 58b (see FIG. 12) to the second outer diameter φ2 is too small, an amount of air taken into the circulation path R2 at the first vent 58b may be excessively small. On the other hand, when the ratio φ4/φ2 of the second inner diameter φ4 to the second outer diameter φ2 is too large, the amount of air taken into the circulation path R2 at the first vent 58b may be excessively large. In the present embodiment, the ratio φ4/φ2 of the second inner diameter φ4 to the second outer diameter φ2 is 33%. Consequently, the amount of air taken into the circulation path R2 at the first vent 58b can be a suitable amount.

### Variants

In the above embodiments, the configuration in which the blower 10 is a backpack blower was described. In another embodiment, the blower 10 may be a blower other than a backpack blower. For example, the blower 10 may be a handheld blower or the like.

In the above embodiment, the configuration in which the blower 10 includes the battery device 12 connected to the blower body 13 via the discharging cable 26 and electric power is supplied from the battery device 12 to the electric motor 54 was described. In another embodiment, instead of the battery device 12, the blower 10 may include at least one battery pack (another example of a battery device) which is disposed at the blower body 13 and detachably attached to a battery attachment portion (not illustrated) including connection terminal(s). When the at least one battery pack is attached to the battery attachment portion, electric power may be supplied from the at least one battery pack to the electric motor 54. In yet another embodiment, instead of the battery device 12, the blower 10 may include a power supply cord for connecting the blower body 13 to an external power source, and the blower 10 may be configured such that electric power is supplied from the external power source to the electric motor 54 via the power supply cord.

In the above embodiment, the configuration in which the airflow pipe 20 includes the first airflow pipe 210, the second airflow pipe 220, the third airflow pipe 230 and the fourth airflow pipe 240 was described. In another embodiment, the airflow pipe 20 may not include at least one of the second airflow pipe 220, the third airflow pipe 230 and the fourth airflow pipe 240.

In the above embodiment, the configuration in which the electric motor 54 is a brushless motor was described. In another embodiment, the electric motor 54 may be a motor other than a brushless motor. For example, the electric motor 54 may be a brushed motor.

In the above embodiment, the configuration in which the fan 52 is an axial flow fan was described. In another embodiment, the fan 52 may be a fan other than an axial flow fan. For example, the fan 52 may be a centrifugal fan such as a sirocco fan.

In the above embodiment, the configuration in which the hub 62 is fixed to the drive shaft 60 was described. In another embodiment, a speed reducer (not illustrated) may be disposed between the hub 62 and the drive shaft 60. In this case, the hub 62 may be fixed to an output shaft different from the drive shaft 60 and the output saft may be coupled to the drive shaft 60 via the speed reducer. In other words, the hub 62 may be rotatably disposed about a rotation axis different from the rotation axis A1 of the drive shaft 60.

In the above embodiment, the configuration in which the cylindrical portion 66, the bottom portion 68, the plurality of support members 72 and the first airflow pipe 210 are seamlessly and integrally formed was described. In another embodiment, at least one of the cylindrical portion 66, the bottom portion 68, the plurality of support members 72 and the first airflow pipe 210 may be formed as separate member(s).

In the above embodiment, the configuration in which resin such as nylon is used for the cylindrical portion 66, the bottom portion 68, the lid portion 70, the plurality of support members 72 and the first airflow pipe 210 was described. In another embodiment, a material other than resin may be used for at least one of the cylindrical portion 66, the bottom portion 68, the lid portion 70, the plurality of support members 72 and the first airflow pipe 210. For example, aluminum or the like may be used for at least one of the cylindrical portion 66, the bottom portion 68, the lid portion 70, the plurality of support members 72 and the first airflow pipe 210.

In the above embodiment, the configuration in which an aluminum alloy is used for the heat dissipation members 86 was described. In another embodiment, a material other than the aluminum alloy may be used for the heat dissipation members 86. For example, silicon rubber or the like may be used for the heat dissipation members 86.

In the above embodiment, the configuration in which a metallic material such as aluminum is used for the controller casing 88 was described. In another embodiment, a material other than a metallic material may be used for the controller casing 88. For example, nylon or the like may be used for the controller casing 88.

In the above embodiment, the configuration in which the exposure hole 216 is defined downstream from (on the outlet side of) the fan 52 and the controller casing 88 is exposed to the airflow path R1 at a position downstream from the fan 52 was described. In another embodiment, the exposure hole 216 may be defined upstream from (on the inlet side of) the fan 52 and the controller casing 88 may be exposed to the airflow path R1 at a position upstream from the fan 52.

In the above embodiment, the configuration in which, when the exposure hole 216 is viewed from the outside of the first airflow pipe 210 in the radial direction, the electric motor 54 and the exposure hole 216 partially overlap was described. In another embodiment, when the exposure hole 216 is viewed from the outside of the first airflow pipe 210 in the radial direction, the electric motor 54 and the exposure hole 216 may not overlap. In this case, the exposure hole 216 may be offset toward the outlet from the electric motor 54 or may be offset toward the inlet from the electric motor 54.

In the above embodiment, the configuration in which the lower surface of the controller casing 88 has a substantially planar shape was described. In another embodiment, the lower surface of the controller casing 88 may not have a substantially planar shape. For example, the lower surface of the controller casing 88 may have a shape along the virtual surface V.

In the above embodiment, the configuration in which the lower surface of the controller casing 88 is offset outwardly in the radial direction of the first airflow pipe 210 from the virtual surface V which extends along the inner surface of the first airflow pipe 210 at a part where the exposure hole 216 is defined was described. In another embodiment, the lower surface of the controller casing 88 may not be offset outwardly in the radial direction of the first airflow pipe 210 from the virtual surface V which extends along the inner surface of the first airflow pipe 210 at a part where the exposure hole 216 is defined. For example, the lower surface of the controller casing 88 may be offset inwardly in the radial direction of the first airflow pipe 210 from the virtual surface V which extends along the inner surface of the first airflow pipe 210 at a part where the exposure hole 216 is defined.

In the above embodiment, the configuration in which the mounting part 212 and the exposure hole 216 are disposed at an upper portion of the first airflow pipe 210 and the control unit 80 is attached to the upper portion of the first airflow pipe 210 was described. In another embodiment, the mounting part 212 and the exposure hole 216 may be disposed at a position other than the upper portion of the first airflow pipe 210 and the control unit 80 may be attached to a portion other than the upper portion of the first airflow pipe 210. For example, the mounting part 212 and the exposure hole 216 may be disposed at, for example, a lower portion of the first airflow pipe 210, and the control unit 80 may be attached to, for example, the lower portion of the first airflow pipe 210.

In the above embodiment, the configuration in which the plurality of switching elements 84 is FETs was described. In another embodiment, the plurality of switching elements 84 may be switching elements other than FETs. For example, the plurality of switching elements 84 may be IGBTs (insulated-gate bipolar transistors) or the like.

In the above embodiment, the configuration in which the ratio φ1/φ2 of the first outer diameter φ1 to the second outer diameter φ2 is 103% was described. In another embodiment, the ratio φ1/φ2 of the first outer diameter φ1 to the second outer diameter φ2 may be suitably changed within a range from 101% to 116%.

In the above embodiment, the configuration in which the ratio φ3/φ2 the first inner diameter φ3 to the second outer diameter φ2 is 187% was described. In another embodiment, the ratio φ3/φ2 of the first inner diameter φ3 to the second outer diameter φ2 may be suitably changed within a range from 175% to 195%.

In the above embodiment, the configuration in which the ratio φ4/φ2 of the second inner diameter φ4 to the second outer diameter φ2 is 33% was described. In another embodiment, the ratio φ4/φ2 of the second inner diameter φ4 to the second outer diameter φ2 may be suitably changed within a range from 15% to 50%.

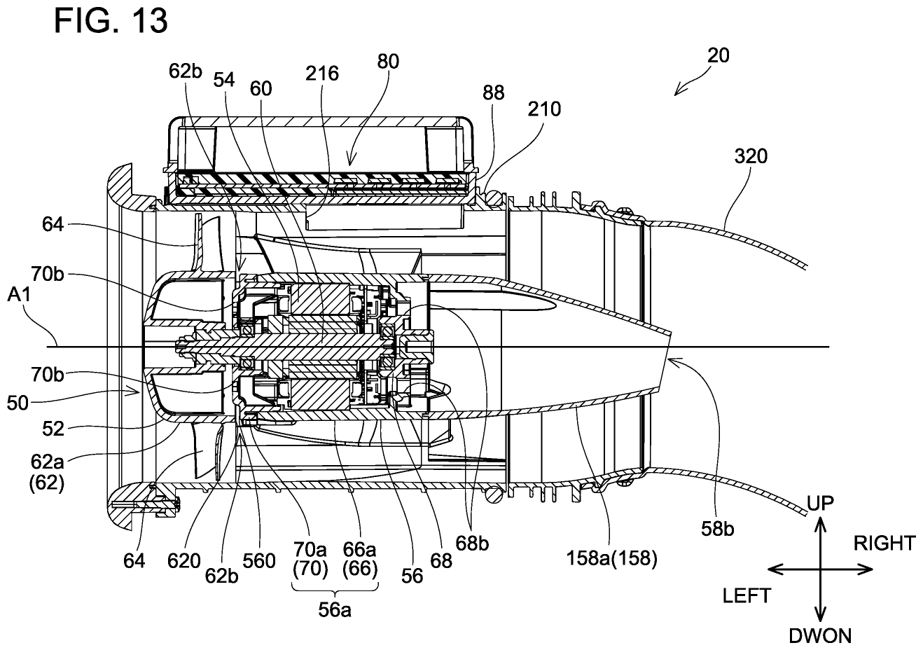

As illustrated in FIG. 13, in another embodiment, the blower 10 may include a second airflow pipe 320 instead of the second airflow pipe 220, and may include a diffuser cone 158 instead of the diffuser cone 58. The second airflow pipe 320 has a shape which curves downward as it extends rightward. The diffuser cone 158 has a shape which curves downward as it extends rightward along the curve shape of the second airflow pipe 320. In this case, the first vent 58b opens along the direction in which the second airflow pipe 320 extends.

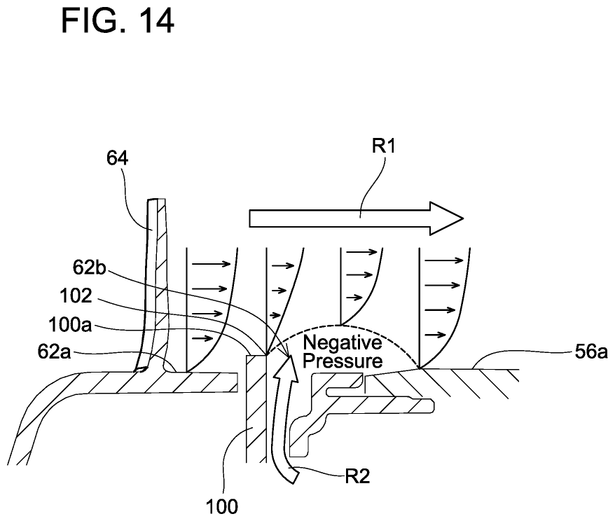

As illustrated in FIG. 14, in another embodiment, a plate member 100 having a circular plate shape may be disposed between the hub 62 and the motor housing 56. The plate member 100 may include an outer surface 100a having an axisymmetric shape about the rotation axis A1. The plate member 100 may be fixed to the drive shaft 60 (see FIG. 4) independently from the hub 62. The second vent 62b may not be defined such that its circumferential end is constituted of the outlet-side end 620 of the hub 62 and the inlet-side end 560 of the motor housing 56. Instead, the second vent 62b may be defined such that its circumferential end is constituted of the inlet-side end 560 and an outlet-side end 102 which is the end of the outer surface 100a of the plate member 100 on the outlet side. Although not illustrated, the outer diameter of the outlet-side end 102 may be larger than the second outer diameter φ2 of the inlet-side end 560. In this configuration, the first outer diameter φ1 of the outlet-side end 620 may be equal to or greater than the second outer diameter φ2 of the inlet-side end 560. In this case, the plate member 100 increases negative pressure which generates airflow in the circulation path R2. In other words, the plate member 100 increases the flow rate of the cooling air for cooling the electric motor 54.

### Corresponding Relationships

As described above, in one or more embodiments, the blower 10 comprises the inlet 30, the outlet 32, the airflow pipe 20 disposed between the inlet 30 and the outlet 32, the fan 52 (an example of an axial flow fan) disposed in the airflow pipe 20 (specifically, the first airflow pipe 210) and including the hub 62 configured to rotate about the predetermined rotation axis A1 which is along the direction in which the airflow pipe 20 extends and the plurality of blades 64 disposed on the first outer surface 62a of the hub 62, the drive shaft 60 disposed in the airflow pipe 20 and connected to the fan 52, the electric motor 54 which is offset from the fan 52 toward the outlet 32 in the airflow pipe 20 and configured to rotate the drive shaft 60, the motor housing 56 that is disposed in the airflow pipe 20 and houses the electric motor 54, the diffuser cone 58 (or the diffuser cone 158) disposed in the airflow pipe 20 and connected to the end of the motor housing 56 on the outlet side, the first vent 58b defined at the end of the diffuser cone 58 (or the diffuser cone 158) on the outlet side, and the second vent 62b defined between the hub 62 and the motor housing 56 along the circumferential direction of the rotation axis A1 and having a width in the axial direction of the rotation axis A1. The airflow path R1 in which the air from the inlet 30 flows to the outlet 32 by flowing outside of the hub 62, outside of the motor housing 56, and outside of the diffuser cone 58 (or the diffuser cone 158) is defined in the airflow pipe 20, and the circulation path R2 in which the air flowing in the airflow path R1 flows into the inside of the diffuser cone 58 (or the diffuser cone 158) through the first vent 58b, flows inside of the motor housing 56, and flows toward the airflow path R1 through the second vent 62b is defined in the airflow pipe 20. When the circumferential end of the second vent 62b on the inlet side is a first end and the circumferential end of the second vent 62b on the outlet side is a second end, the first end is the outlet-side end 620 (or the outlet-side end 102) and the second end is the inlet-side end 560. The first outer diameter φ1 of the outlet-side end 620 (or the outer diameter of the outlet-side end 102) is larger than the second outer diameter φ2 of the inlet-side end 560.

In the above configuration, the air flowing along the first outer surface 62a of the hub 62 among the air flowing in the airflow path R1 separates from the first outer surface 62a of the hub 62 at the outlet-side end 620 (or the outlet-side end 102) and comes into contact again with the second outer surface 56a of the motor housing 56 at a position offset from the inlet-side end 560 toward the outlet side. According to the above configuration, by virtue of the first outer diameter φ1 of the outlet-side end 620 (or the outer diameter of the outlet-side end 102) being larger than the second outer diameter φ2 of the inlet-side end 560, the distance between the point at which the air separates (i.e., the separation point) and the point at which the separated air comes into contact again (i.e., the recontact point) increases. Thus, negative pressure which generates airflow in the circulation path R2 increases, by which the flow rate of the cooling air for the electric motor 54 can be increased. According to the above configuration, in the blower 10, the electric motor 54 housed in the motor housing 56 can suitably be cooled.

In one or more embodiments, the first end is the outlet-side end 620 (an example of an end of the outer surface of the hub on the outlet side). The second end is the inlet-side end 560 (an example of an end of an outer surface of the motor housing on the inlet side).

As a means to increase the flow rate of the cooling air for the electric motor 54, another member may be provided between, for example, the hub 62 and the motor housing 56. On the other hand, according to the above configuration, the flow rate of the cooling air for the electric motor 54 can be increased without providing another member between the hub 62 and the motor housing 56. Consequently, the number of parts of the blower 10 can be reduced.

In one or more embodiments, the blower 10 further comprises the plate member 100 (an example of a negative pressure increasing member) disposed between the hub 62 and the motor housing 56 and including the outer surface 100a having the axisymmetric shape about the rotation axis A1. The first end is the outlet-side end 102 (an example of an end of the outer surface of the plate member on the outlet side). The second end is the inlet-side end 560 (an example an end of an outer surface of the motor housing on the inlet side).

According to the above configuration, by retrofitting the plate member 100 between the hub 62 and the motor housing 56 of the general blower 10, the flow rate of the cooling air for the electric motor 54 can be increased. Consequently, with a simple and inexpensive configuration, the flow rate of the cooling air for the electric motor 54 can be increased.

In one or more embodiments, the hub 62 is fixed to the drive shaft 60. The rotation axis A1 is coincident with the rotation axis A1 of the drive shaft 60.

According to the above configuration, the blower 10 can be downsized as compared to the case in which a speed reducer and/or the like is provided between the hub 62 and the drive shaft 60.

In one or more embodiments, the ratio φ1/φ2 of the first outer diameter φ1 of the outlet-side end 620 to the second outer diameter φ2 of the inlet-side end 560 is within a range from 101% to 116%.

When the ratio φ1/φ2 of the first outer diameter φ1 of the outlet-side end 620 to the second outer diameter φ2 of the inlet-side end 560 is too small, negative pressure which generates airflow in the circulation path R2 may not sufficiently be increased. In other words, the flow rate of the cooling air for the electric motor 54 may not sufficiently be increased. On the other hand, when the ratio φ1/φ2 of the first outer diameter φ1 of the outlet-side end 620 to the second outer diameter φ2 of the inlet-side end 560 is too large, separation of air flowing along the first outer surface 62a may disturb the airflow generated in the airflow path R1 by driving the fan 52. In other words, due to disturbance of the airflow, the flow rate of the blowing air may greatly be reduced. According to the above configuration, the flow rate of the cooling air for the electric motor 54 can sufficiently be increased and reduction of the flow rate of the blowing air can be suppressed.

In one or more embodiments, the ratio φ3/φ2 of the first inner diameter φ3 of the first airflow pipe 210 radially outside the outlet-side end 620 to the second outer diameter φ2 of the inlet-side end 560 is within a range from 175% to 195%.

When the ratio φ3/φ2 of the first inner diameter φ3 of the first airflow pipe 210 radially outside the outlet-side end 620 to the second outer diameter φ2 of the inlet-side end 560 is too small, increasing the first outer diameter φ1 of the outlet-side end 620 narrows the airflow path R1, by which pressure loss may be increased to a great extent in the airflow path R1. On the other hand, when the ratio φ3/φ2 of the first inner diameter φ3 of the first airflow pipe 210 radially outside the outlet-side end 620 to the second outer diameter φ2 of the inlet-side end 560 is too large, the airflow generated in the airflow path R1 by driving the fan 52 may be disturbed. According to the above configuration, it is possible to suppress increase in pressure loss in the airflow path R1 and also suppress disturbance of the airflow in the airflow path R1.

In one or more embodiments, the first vent 58b has the circumferential end having a substantially circular shape and opening along the direction in which the first airflow pipe 210 extends (or the direction in which the second airflow pipe 320 extends). The ratio φ4/φ2 of the second inner diameter φ4 of the first vent 58b to the second outer diameter φ2 of the inlet-side end 560 is within a range from 15% to 50%.

When the ratio φ4/φ2 of the second inner diameter φ4 of the first vent 58b to the second outer diameter φ2 of the inlet-side end 560 is too small, an amount of air taken into the circulation path R2 at the first vent 58b may excessively be small. On the other hand, when the ratio φ4/φ2 of the second inner diameter φ4 of the first vent 58b to the second outer diameter φ2 of the inlet-side end 560 is too large, the amount of air taken into the circulation path R2 at the first vent 58b may excessively be large. According to the above configuration, when the first vent 58b is opened along the direction in which the first airflow pipe 210 extends (or the direction in which the second airflow pipe 320 extends), the amount of air taken into the circulation path R2 in the first vent 58b can be set to a suitable amount.

In one or more embodiments, the blower 10 further comprises the battery device 12 (or at least one battery pack) (an example of a battery device) configured to supply electric power to the electric motor 54. The electric motor 54 is configured to be driven by electric power supplied from the battery device 12 (or the at least one battery pack).

When the electric motor 54 is driven by electric power supplied from an external power source, it is necessary to attach a power supply cord to the blower 10, which may degrade maneuverability. According to the above configuration, it is not necessary to attach the power supply cord to the blower 10, by which user maneuverability can further be improved. Further, since the blower 10 can be used even at a place where an external power source cannot be provided, user convenience can also be enhanced.

In one or more embodiments, the blower 10 further comprises the battery attachment portion including the connection terminal(s). The battery device is at least one battery pack configured to be attached to and detached from the battery attachment portion.

For example, when the battery device is attached to the blower 10 such that it cannot be attached to or detached from the blower 10, work using the blower 10 cannot immediately be resumed until the battery device is charged again after the work is stopped due to the battery device being out of power. According to the above configuration, even when the work is stopped due to the battery pack being out of power, the work using the blower 10 can immediately be resumed by replacing the battery pack with a battery pack charged in advance.

In one or more embodiments, the blower 10 further comprises the power supply cord configured to be connected to the external power source. The electric motor 54 is configured to be driven by electric power supplied from the external power source.

When the electric motor 54 is driven using the electric power supplied from the battery source included in the blower 10, it is necessary to charge the battery device in advance, which may be an inconvenience for a user. According to the above configuration, the blower 10 can immediately be used by connecting the power supply cord to the external power source, thus preparation such as charging of the battery device in advance is not necessary. Consequently, the inconvenience which the user may feel can be reduced.

What is claimed is:

1. A blower, comprising:
an inlet;
an outlet;
an airflow pipe disposed between the inlet and the outlet;
an axial flow fan disposed in the airflow pipe and including a hub configured to rotate about a predetermined rotation axis which is along a direction in which the airflow pipe extends, and a plurality of blades disposed on an outer surface of the hub;
a drive shaft disposed in the airflow pipe and connected to the axial flow fan;
an electric motor which is offset from the axial flow fan toward the outlet in the airflow pipe and configured to rotate the drive shaft;
a motor housing that is disposed in the airflow pipe and houses the electric motor;
a diffuser cone disposed in the airflow pipe and connected to an end of the motor housing on an outlet side;
a first vent defined at an end of the diffuser cone on the outlet side; and
a second vent defined between the hub and the motor housing along a circumferential direction of the rotation axis and having a width in an axial direction of the rotation axis,
wherein an airflow path in which air from the inlet flows to the outlet by flowing outside of the hub, outside of the motor housing, and outside of the diffuser cone is defined in the airflow pipe,
a circulation path in which the air flowing in the airflow path flows into inside of the diffuser cone through the first vent, flows inside of the motor housing, and flows toward the airflow path through the second vent is defined in the airflow pipe, and
when a circumferential end of the second vent on the inlet side is a first end and a circumferential end of the second vent on the outlet side is a second end, an outer diameter of the first end is larger than an outer diameter of the second end.

2. The blower according to claim 1, wherein the first end is an end of the outer surface of the hub on the outlet side, and
the second end is an end of an outer surface of the motor housing on the inlet side.

3. The blower according to claim 1, further comprising a negative pressure increasing member disposed between the hub and the motor housing and including an outer surface having an axisymmetric shape about the rotation axis,
wherein the first end is an end of the outer surface of the negative pressure increasing member on the outlet side, and
the second end is an end of an outer surface of the motor housing on the inlet side.

4. The blower according to claim 1, wherein the hub is fixed to the drive shaft, and
the rotation axis is coincident with a rotation axis of the drive shaft.

5. The blower according to claim 1, wherein a ratio of the outer diameter of the first end to the outer diameter of the second end is within a range from 101% to 116%.

6. The blower according to claim 5, wherein a ratio of an inner diameter of the airflow pipe radially outside the first end to the outer diameter of the second end is within a range from 175% to 195%.

7. The blower according to claim 1, wherein the first vent has a circumferential end having a substantially circular shape and opening along the direction in which the airflow pipe extends, and
a ratio of an inner diameter of the first vent to the outer diameter of the second end is within the range from 15% to 50%.

8. The blower according to claim 1, further comprising a battery device,
wherein the electric motor is configured to be driven by electric power supplied from the battery device.

9. The blower according to claim 8, further comprising a battery attachment portion including a connection terminal,
wherein the battery device is at least one battery pack configured to be attached to and detached from the battery attachment portion.

10. The blower according to claim 1, further comprising a power supply cord configured to be connected to an external power source,
wherein the electric motor is configured to be driven by electric power supplied from the external power source.

11. The blower according to claim 2, wherein the hub is fixed to the drive shaft,
the rotation axis is coincident with a rotation axis of the drive shaft,
a ratio of the outer diameter of the first end to the outer diameter of the second end is within a range from 101% to 116%,
a ratio of an inner diameter of the airflow pipe radially outside the first end to the outer diameter of the second end is within a range from 175% to 195%,
the first vent has a circumferential end having a substantially circular shape and opening along the direction in which the airflow pipe extends,
a ratio of an inner diameter of the first vent to the outer diameter of the second end is within the range from 15% to 50%,
the blower further comprises a battery device,
the electric motor is configured to be driven by electric power supplied from the battery device,
the blower further comprises a battery attachment portion including a connection terminal, and
the battery device is at least one battery pack configured to be attached to and detached from the battery attachment portion.

12. The blower according to claim 3, wherein the hub is fixed to the drive shaft,
the rotation axis is coincident with a rotation axis of the drive shaft,
a ratio of the outer diameter of the first end to the outer diameter of the second end is within a range from 101% to 116%,
a ratio of an inner diameter of the airflow pipe radially outside the first end to the outer diameter of the second end is within a range from 175% to 195%,
the first vent has a circumferential end having a substantially circular shape and opening along the direction in which the airflow pipe extends,
a ratio of an inner diameter of the first vent to the outer diameter of the second end is within the range from 15% to 50%,
the blower further comprises a battery device,
the electric motor is configured to be driven by electric power supplied from the battery device,
the blower further comprises a battery attachment portion including a connection terminal, and
the battery device is at least one battery pack configured to be attached to and detached from the battery attachment portion.

13. The blower according to claim 2, wherein the hub is fixed to the drive shaft,
the rotation axis is coincident with a rotation axis of the drive shaft,
a ratio of the outer diameter of the first end to the outer diameter of the second end is within a range from 101% to 116%,
a ratio of an inner diameter of the airflow pipe radially outside the first end to the outer diameter of the second end is within a range from 175% to 195%,
the first vent has a circumferential end having a substantially circular shape and opening along the direction in which the airflow pipe extends,
a ratio of an inner diameter of the first vent to the outer diameter of the second end is within the range from 15% to 50%,
the blower further comprises a battery device,
the electric motor is configured to be driven by electric power supplied from the battery device,
the blower further comprises a power supply cord configured to be connected to an external power source, and
the electric motor is configured to be driven by electric power supplied from the external power source.

14. The blower according to claim 3, wherein the hub is fixed to the drive shaft,
the rotation axis is coincident with a rotation axis of the drive shaft,
a ratio of the outer diameter of the first end to the outer diameter of the second end is within a range from 101% to 116%,
a ratio of an inner diameter of the airflow pipe radially outside the first end to the outer diameter of the second end is within a range from 175% to 195%,
the first vent has a circumferential end having a substantially circular shape and opening along the direction in which the airflow pipe extends,
a ratio of an inner diameter of the first vent to the outer diameter of the second end is within the range from 15% to 50%,
the blower further comprises a battery device,
the electric motor is configured to be driven by electric power supplied from the battery device,
the blower further comprises a power supply cord configured to be connected to an external power source, and
the electric motor is configured to be driven by electric power supplied from the external power source.
